(19) United States
(12) Patent Application Publication
(10) Pub. No.: US 2012/0174137 A1
(43) Pub. Date: Jul. 5, 2012

(54) ELECTRONIC DEVICE WITH SLOPED RECESS FOR OPTICAL DISK

(75) Inventors: HONG LI, Shenzhen City (CN); XUE-DONG TANG, Shenzhen City (CN); LI-NI LIANG, Shenzhen City (CN); PING LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shengzhen City (CN)

(21) Appl. No.: 13/073,949

(22) Filed: Mar. 28, 2011

(30) Foreign Application Priority Data
Dec. 31, 2010 (CN) 201010616646.4

(51) Int. Cl. G11B 33/12

(52) U.S. Cl. 720/652; G9B/33.027

(57) ABSTRACT

An exemplary electronic device includes a shell and a driving module disposed at an inner side of the shell. The driving module has a rotating shaft. The shell defines a recess. The rotating shaft extends through the recess of the shell and is located at a center of the recess. The recess of the shell includes a torus area. The torus area includes an inner side near the rotating shaft, and an outer side far from the rotating shaft. A bottom face of the recess slants gradually and downwardly from the inner side to the outer side of the torus area.

### BACKGROUND

1. Technical Field

The disclosure relates to electronic devices, and particularly to an electronic device with a recess which can prevent an optical disk mounted therein from getting scratched.

2. Description of Related Art

An electronic device such as a DVD (Digital Video Disc) player generally includes a casing, and a driving module disposed substantially inside the casing. The driving module includes a rotating shaft. When an optical disk is mounted on the rotating shaft, the driving module can drive the optical disk to rotate. The casing defines a shallow circular groove, the rotating shaft is located at a center of the groove, and the optical disk is received in the groove. A bottom face of the groove of the casing is spaced from a bottom face of the optical disk a certain distance (commonly 1.5 mm) Although this interval between the casing and the optical disk can to some extent prevent the optical disk from getting scratched, an outer area of the optical disk is still liable to be scratched by the bottom face of the groove of the casing when the optical disk rotates at a higher speed and vibrates more.

What is needed, therefore, is an electronic device which can overcome the limitations described.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric, assembled view of an electronic device in accordance with one embodiment of the disclosure, showing an optical disk mounted on the electronic device.

FIG. 2 is similar to FIG. 1, but showing the optical disk removed from the electronic device.

FIG. 3 is an exploded view of the electronic device of FIG. 2, together with the optical disk.

FIG. 4 is a cross sectional view of the electronic device and optical disk of FIG. 1, taken along line IV-IV thereof.

### DETAILED DESCRIPTION

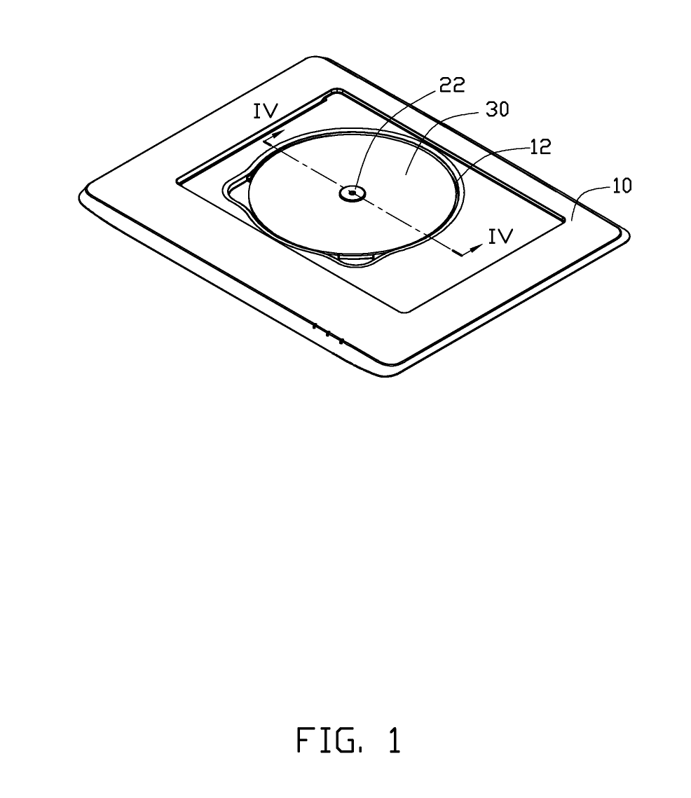

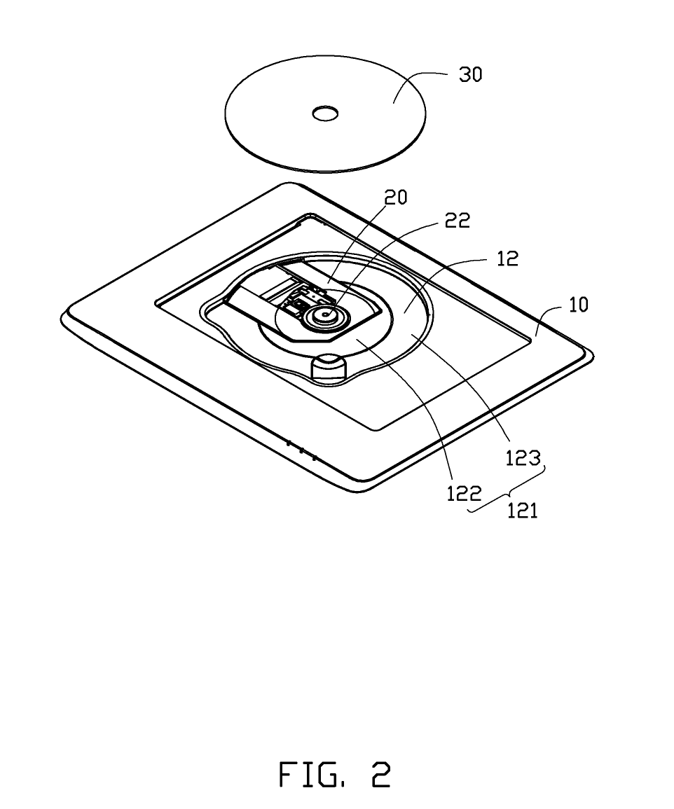

Referring to FIGS. 1-2, an electronic device in accordance with an embodiment of the disclosure is shown. In this embodiment, the electronic device is a DVD player. The electronic device includes a shell 10, and a driving module 20 disposed substantially inside the shell 10.

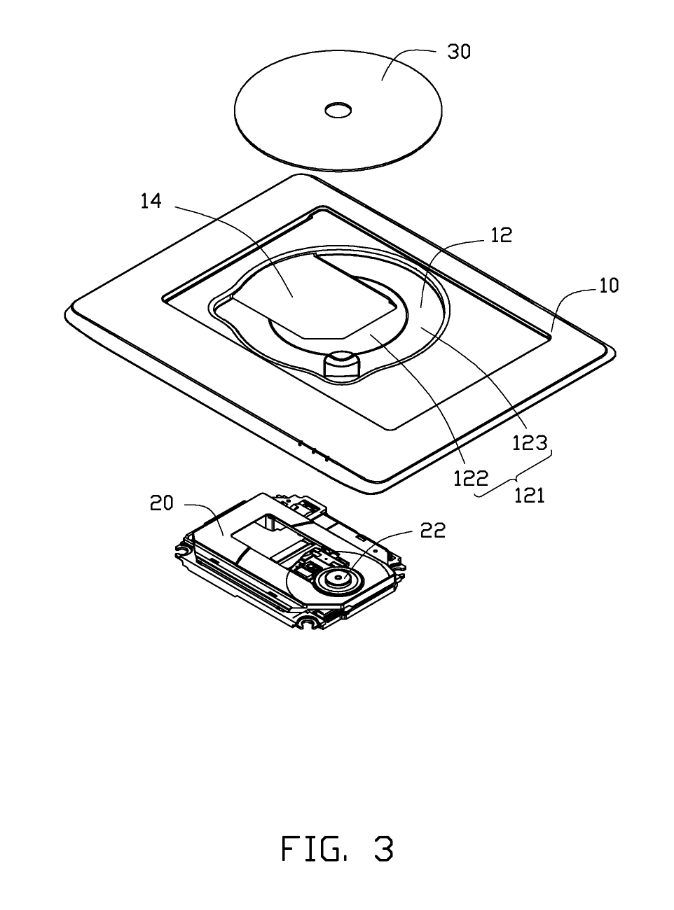

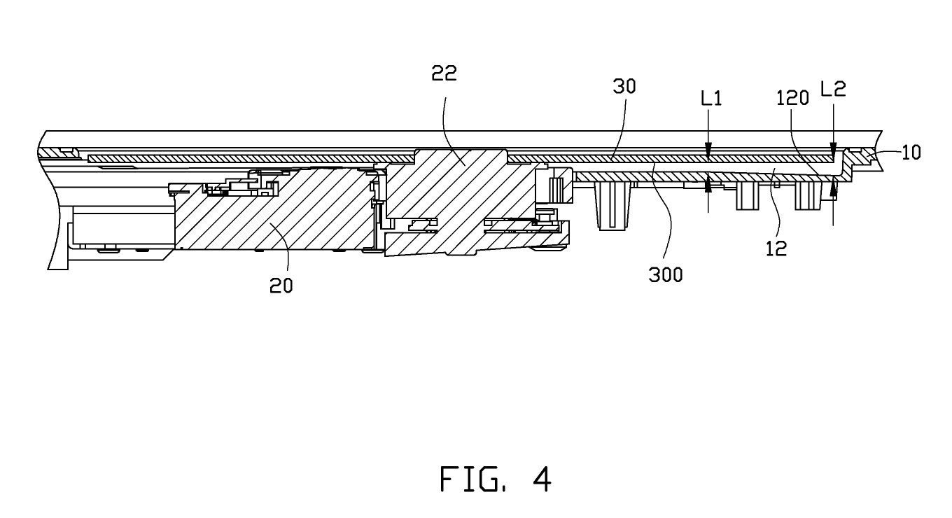

Also referring to FIGS. 3-4, the shell 10 defines a shallow, substantially circular recess 12. A bottom wall of the recess 12 defines a substantially rectangular cutout 14 in a left side thereof. The driving module 20 is substantially rectangular, and has a rotating shaft 22. A portion of the driving module 20 including the rotating shaft 22 extends through the cutout 14 of the casing 10. The rotating shaft 22 is located at a center of the recess 12. An optical disk 30 is mounted on the rotating shaft 22 and thus received in the recess 12. The driving module 20 can drive the optical disk 30 to rotate in the recess 12. The bottom wall of the recess 12 has a bottom face 120, which is opposite to a bottom face 300 of the optical disk 30. The recess 12 of the shell 10 includes a generally torus (or generally annular) area 121. The torus area 121 is concentric with the rotating shaft 22. The torus area 121 includes a generally annular inner side (or portion) 122 near the rotating shaft 22, and a generally annular outer side (or portion) 123 far from the rotating shaft 22 and adjoining the inner side 122. The bottom face 120 of the recess 12 gradually slants radially downwardly from an outmost extremity of the inner side 122 to an outmost extremity of the outer side 123 of the torus area 121. Correspondingly, a distance between the bottom face 120 of the recess 12 and the bottom face 300 of the optical disk 30 gradually increases from the outmost extremity of the inner side 122 to the outmost extremity of the outer side 123 of the torus area 121. In this embodiment, a vertical distance L1 between the bottom face 120 at the outmost extremity of the inner side 122 of the torus area 121 and the bottom face 300 of the optical disk 30 is set to be approximately 1.5 mm (millimeters). A vertical distance L2 between the bottom face 120 near the outmost extremity of the outer side 123 of the torus area 121 and an outmost extremity of the bottom face 300 of the optical disk 30 is set to be approximately 1.7 mm.

When the optical disk 30 is driven to rotate in the recess 12 by the driving module 20, since the distance between the bottom face 120 of the recess 12 and the bottom face 300 of the optical disk 30 radially increases gradually from the inner side 122 to the outer side 123 of the torus area 121, even if the optical disk 30 vibrates to a relatively large extent, an outer periphery of the optical disk 30 is still apt to not be scratched or damaged by the bottom face 120 of the recess 12.

It is believed that the embodiment(s) and its advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An electronic device comprising:
a shell defining a recess, the recess comprising a generally torus area; and
a driving module disposed at an inner side of the shell, the driving module having a rotatable shaft, the rotatable shaft extending through the recess of the shell and being located at a center of the recess, the torus area comprising an inner side nearer the rotatable shaft and an outer side farther from the rotatable shaft and adjacent to the inner side, a bottom face of the recess gradually slanting radially downwardly from an outer area of the inner side to an outer area of the outer side of the torus area;
wherein when an optical disk is mounted on the rotatable shaft of the driving module, the bottom face of the recess faces a bottom face of the optical disk, and a distance between the bottom face of the recess and the bottom face of the optical disk gradually increases from the outer area of the inner side to the outer area of the outer side of the torus area.

2. The electronic device of claim 1, wherein when the optical disk is mounted on the rotatable shaft of the driving module, the distance between the bottom face of the recess at the outer area of the inner side of the torus area and the bottom face of the optical disk is approximately 1.5 mm, and the distance between the bottom face of the recess near the outer area of the outer side of the torus area and the bottom face of the optical disk is approximately 1.7 mm.

3. The electronic device of claim 1, wherein the electronic device is a Digital Video Disc (DVD) player.

4. The electronic device of claim 1, wherein a bottom wall of the recess defines a cutout in a side thereof, a portion of the driving module including the rotatable shaft extending through the cutout into the recess.

5. The electronic device of claim 1, wherein the torus area is concentric with the rotatable shaft.

6. An electronic device comprising:
a shell defining a recess, the recess of the shell comprising a generally torus area; and
a driving module disposed at an inner side of the shell, the driving module having a rotatable shaft, the rotatable shaft extending into the recess of the shell, the torus area comprising an inner side nearer the rotatable shaft and an outer side farther from the rotatable shaft and adjacent to the inner side, a depth of the recess gradually increasing in a radial direction from an outer area of the inner side to an outer area of the outer side of the torus area.

7. The electronic device of claim 6, wherein when an optical disk is mounted on the rotatable shaft of the driving module, a distance between a bottom face of the recess at the outer extremity of the inner side of the torus area and a bottom face of the optical disk is approximately 1.5 mm, and a distance between the bottom face of the recess near the outer area of the outer side of the torus area and the bottom face of the optical disk is approximately 1.7 mm.

8. The electronic device of claim 6, wherein the electronic device is a Digital Video Disc (DVD) player.

9. The electronic device of claim 6, wherein a bottom wall of the recess defines a cutout in a side thereof, a portion of the driving module including the rotatable shaft extending through the cutout into the recess.

10. The electronic device of claim 6, wherein the torus area is concentric with the rotatable shaft.

11. The electronic device of claim 6, wherein the rotatable shaft is located at a center of the recess.

12. An electronic device comprising:
a shell defining a recess adapted for receiving an optical disk; and
a driving module disposed at an inner side of the shell, the driving module having a rotary shaft, the rotary shaft extending into the recess of the shell, the recess comprising an inner annular portion and an outer annular portion adjacent to the inner annular portion, a bottom face of the recess radially slanting gradually downwardly from a periphery of the inner annular portion to a periphery of the outer annular portion.

13. The electronic device of claim 12, wherein when an optical disk is mounted on the rotary shaft of the driving module, a distance between the bottom face of the recess at the periphery of the inner annular portion of the recess and a bottom face of the optical disk is approximately 1.5 mm, and a distance between the bottom face of the recess near the periphery of the outer annular portion of the recess and the bottom face of the optical disk is approximately 1.7 mm.

14. The electronic device of claim 12, wherein the electronic device is a Digital Video Disc (DVD) player.

15. The electronic device of claim 12, wherein a bottom wall of the recess defines a cutout in a side thereof, a portion of the driving module including the rotary shaft extending through the cutout into the recess.

16. The electronic device of claim 12, wherein the rotary shaft is located at a center of the recess.
